(19) United States
(12) Patent Application Publication
(10) Pub. No.: US 2024/0113811 A1
(43) Pub. Date: Apr. 4, 2024

(54) ELECTRONIC DEVICE AND OPERATION METHOD OF ELECTRONIC DEVICE

(71) Applicant: Samsung Electronics Co., Ltd., Suwon-si (KR)

(72) Inventors: Wondeuk YOON, Suwon-si (KR); Sangho LEE, Suwon-si (KR); Morten Mandrup HANSEN, Suwon-si (KR)

(73) Assignee: Samsung Electronics Co., Ltd., Suwon-si (KR)

(21) Appl. No.: 18/475,825

(22) Filed: Sep. 27, 2023

(30) Foreign Application Priority Data
Oct. 4, 2022 (KR) 10-2022-0126237

(51) Int. Cl. H04L 1/1607; H04W 4/80

(52) U.S. Cl. CPC H04L 1/1607; H04W 4/80

(57) ABSTRACT

Disclosed are operation methods of electronic devices that perform short-range wireless communication. The method includes receiving a data packet from an outside, determining whether to send a response signal, based on valid information indicating validation of the received data packet, data check information indicating whether there are data to be transmitted to the outside, and flush information indicating whether a current sub-event is a last sub-event just before a flush point for the received data packet, in response to the received data packet, and sending the response signal in consideration of a result of the determining whether to send the response signal.

### CROSS-REFERENCE TO RELATED APPLICATIONS

This application claims priority under 35 U.S.C. § 119 to Korean Patent Application No. 10-2022-0126237 filed on Oct. 4, 2022, in the Korean Intellectual Property Office, the disclosures of which are incorporated by reference herein in their entireties.

### BACKGROUND

Example embodiments of the present disclosure described herein relate to electronic devices, and more particularly, relate to low-power electronic devices performing short-range wireless communication, and operation methods of the electronic devices.

With the development of wireless communication technologies, an electronic device may communicate with another electronic device through various wireless communication technologies. With the development of wireless communication technologies, various types of wearable devices are appearing and are widely used together with a smartphone. In particular, in relation to a headset used to listen to music or to make a call, the user's changeover from a product using an existing wired connection manner to a product using a wireless communication technology such as Bluetooth is rapidly increasing, and even in a wireless environment, the demand for high-quality audio streaming that is capable of being supported in a wired environment is increasing.

The Bluetooth communication technology refers to a short-range wireless communication technology that allows electronic devices to connect to each other and to exchange data or information. Also, the Bluetooth communication technology may include a Bluetooth legacy (or classic) network technology or a Bluetooth low energy (BLE) network.

### SUMMARY

Example embodiments of the present disclosure provide low-power electronic devices performing short-range wireless communication and operation methods of the electronic devices.

According to some example embodiments, an operation method of an electronic device that performs short-range wireless communication includes receiving a data packet from an outside, determining whether to send a response signal, based on valid information indicating validation of the received data packet, data check information indicating whether there are data to be transmitted to the outside, and flush information indicating whether a current sub-event is a last sub-event just before a flush point for the received data packet, in response to the received data packet, and sending the response signal in consideration of a result of the determining whether to send the response signal.

According to some example embodiments, an operation method of an electronic device that communicates with an external device through short-range wireless communication includes receiving a data packet from the external device, determining whether a specific condition is satisfied in which a response signal is not transmitted, in response to the received data packet, and keeping silent without sending the response signal to the external device based on the specific condition being satisfied, and a low energy connected isochronous stream (CIS) is configured to perform the short range wireless communication.

According to some example embodiments, an electronic device includes a host, and a controller. The controller is configured to determine whether to send a response signal, based on valid information indicating validation of a data packet received from an outside, data check information indicating whether there are data to be transmitted to the outside, and flush information indicating whether a current sub-event is a last sub-event just before a flush point for the received data packet, in response to the received data packet, and send no response signal to the outside based on satisfied a specific condition being satisfied in which the response signal is not transmitted.

### BRIEF DESCRIPTION OF THE FIGURES

The above and other objects and features of the present disclosure will become apparent by describing in detail embodiments thereof with reference to the accompanying drawings.

FIG. 1 is a block diagram of a wireless communication system according to some example embodiments of the present disclosure.

FIG. 2 is a block diagram illustrating a link layer of FIG. 1 in detail.

FIGS. 3 and 4 are flowcharts illustrating an example of operations of first and second electronic devices of FIG. 1.

FIG. 5 is a diagram illustrating an example of a method in which a wireless communication system of FIG. 1 sends/receives data.

FIG. 6 is a diagram illustrating an example of an operation method of a wireless communication system.

FIG. 7 is a diagram illustrating an example of an operation method of a wireless communication system of FIG. 1.

FIGS. 8 to 11 are diagrams illustrating an example of an operation of a wireless communication system of FIG. 1.

FIG. 12 is a block diagram of an electronic device in a network environment according to some example embodiments.

FIG. 13 is a diagram illustrating an electronic device and a wireless audio input/output device according to some example embodiments of the present disclosure.

### DETAILED DESCRIPTION

Below, example embodiments of the present disclosure will be described in detail and clearly to such an extent that an ordinary one in the art easily implements the inventive concepts.

The terms “unit”, “module”, etc. to be used below and function blocks illustrated in drawings may be implemented in the form of a software component, a hardware component, or a combination thereof. Below, to describe the technical idea of the inventive concepts clearly, a description associated with identical components will be omitted.

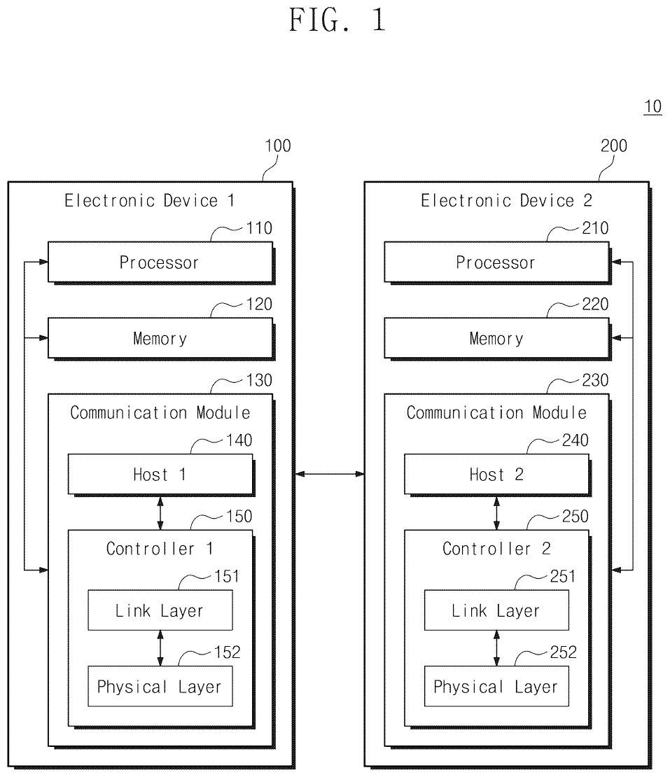

FIG. 1 is a block diagram of a wireless communication system according to some example embodiments of the present disclosure. Referring to FIG. 1, a wireless communication system 10 may include a first electronic device 100 and a second electronic device 200. In the wireless communication system 10, the first electronic device 100 may communicate with the second electronic device 200 over a network (e.g., a short-range wireless communication network) or a wireless communication link.

Some example embodiments of the present disclosure will be described in detail with reference to a Bluetooth low energy audio communication manner as a short-range communication manner, but the present disclosure is not limited thereto.

The first electronic device 100 may include a processor 110, a memory 120, and a communication module 130. The communication module 130 may include a first host 140 and a first controller 150. The first controller 150 may include a link layer 151 and a physical layer 152. In some example embodiments, the first host 140 may be implemented on the processor 110 or may be implemented on a separate processor. The first host 140 and the first controller 150 may be implemented on a single processing unit (e.g., a low-power device) or may be implemented with separate processing units.

The second electronic device 200 may include a processor 210, a memory 220, and a communication module 230. The communication module 230 may include a second host 240 and a second controller 250. The second controller 250 may include a link layer 251 and a physical layer 252. In some example embodiments, the second host 240 may be implemented on the processor 210 or may be implemented on a separate processor. The second host 240 and the second controller 250 may be implemented on a single processing unit (e.g., a low-power device) or may be implemented with separate processing units.

In some example embodiments, the communication modules 130 and 230 may be implemented based on the Bluetooth® protocol being a short-range wireless communication protocol. The Bluetooth protocol is composed of a BR/EDR (Basic Rate/Enhanced Data Rate) protocol and a BLE (Bluetooth Low Energy) protocol. The communication modules 130 and 230 according to some example embodiments of the present disclosure may be implemented to comply with the standard regulation such as an LE Audio protocol being a BLE-based audio streaming technology.

For example, the first and second electronic devices 100 and 200 may communicate through a short-range wireless communication BLE connected isochronous stream CIS. The connected isochronous stream CIS may be used to simultaneously send audio data to a plurality of specific devices through ACL (Asynchronous Connection-Less) connection in the connected state. The connected isochronous stream CIS may send/receive ISO data (or CIS data) at a specific time based on parameters that are exchanged between a central device (e.g., the first electronic device 100) and a peripheral device (e.g., the second electronic device 200) by using the time synchronization-based communication protocol.

For example, according to the LE Audio standard, the first and second electronic devices 100 and 200 may implement a multiple music streaming function. The first and second electronic devices 100 and 200 may perform isochronous-based data communication.

In some example embodiments, the first and second hosts 140 and 240 may communicate with the first and second controllers 150 and 250 through a host controller interface (HCI). To establish and/or maintain the connection, the first host 140 may provide an HCI command to the link layer 151 of the first controller 150, and the second host 240 may provide an HCI command to the link layer 251 of the second controller 250. The link layers 151 and 251 may manage advertisement, scanning, and connection establishment.

In some example embodiments, the first electronic device 100 may be a central device, and the second electronic device 200 may be a peripheral device. Alternatively, the first electronic device 100 may be a master device, and the second electronic device 200 may be a slave device.

In some example embodiments, the first electronic device 100 and the second electronic device 200 may perform short-range wireless communication. The first electronic device 100 may establish the wireless communication connection with the second electronic device 200 by using the short-range wireless communication manner. For example, the first electronic device 100 may establish the wireless communication connection with the second electronic device 200 by using the communication module 130 and may exchange data or packets with the second electronic device 200 based on the wireless communication connection. For example, the packet may have a packet structure that is used in the short-range wireless communication manner.

In some example embodiments, the first electronic device 100 may send data or a packet to the second electronic device 200. When the second electronic device 200 fails to receive data or a packet from the first electronic device 100 or receives invalid data or an invalid packet, the second electronic device 200 may send a negative acknowledgement signal (hereinafter referred to as an “NACK signal”) to the first electronic device 100. When the first electronic device 100 receives the NACK signal, the first electronic device 100 may resend the data or packet that is previously transmitted. When the second electronic device 200 receives valid data or a valid packet from the first electronic device 100, the second electronic device 200 may send an acknowledgement signal (hereinafter referred to as an “ACK signal”) to the first electronic device 100. When the first electronic device 100 receives the ACK signal, the first electronic device 100 may send next data or a next packet.

In some example embodiments, regardless of receiving the NACK signal corresponding to the transmitted packet, when the first electronic device 100 does not receive the ACK signal, the first electronic device 100 may send (or resend) the same data or packet to the second electronic device 200 until a flush point. After the flush point, regardless of the ACK/NACK signal provided from the second electronic device 200, the first electronic device 100 may send next data or a next packet (e.g., a next CIS protocol data unit (PDU)) to the second electronic device 200.

In some example embodiments, the second electronic device 200 according to some example embodiments of the present disclosure may not send a response signal. The second electronic device 200 may not send any response signal in a sub-event. The second electronic device 200 may not send both the ACK signal and the NACK signal. In other words, in response to the data or packet received from the first electronic device 100, the second electronic device 200 may not respond when a specific condition is satisfied. That is, the second electronic device 200 may keep silent in response to the data or packet received from the first electronic device 100.

For example, the second electronic device 200 may not send the NACK signal. In detail, the second electronic device 200 may fail to receive data or a packet from the first electronic device 100 or may receive invalid data or an invalid packet from the first electronic device 100. When there is no data to be provided to the first electronic device 100, the second electronic device 200 may not send the NACK signal.

For example, the second electronic device 200 may not send the ACK signal. The second electronic device 200 may receive valid data or a valid packet from the first electronic device 100. When a current sub-event is a sub-event just before the flush point for the received data or packet and there is no data to be provided to the first electronic device 100, the second electronic device 200 may not send the ACK signal.

As described above, the wireless communication system 10 according to some example embodiments of the present disclosure may not send/receive unnecessary packets or data (e.g., packets/data that are not necessary for a specific operation, or may only send/receive a necessary or minimum amount of packets or data that may be required for a successful operation). The second electronic device 200 may not send any response signal to the first electronic device 100 under a specific condition. As such, the power consumption of the second electronic device 200 may decrease. An operation method of the wireless communication system 10 according to some example embodiments of the present disclosure will be described in detail with reference to the following drawings.

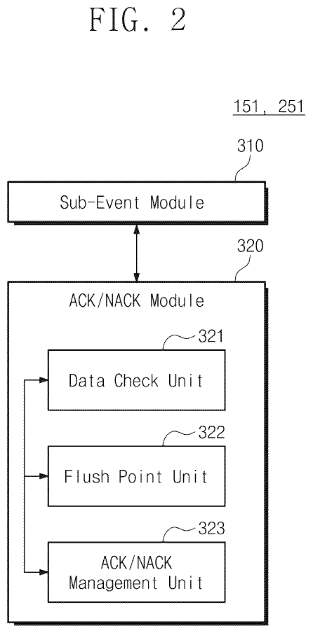

FIG. 2 is a block diagram illustrating a link layer of FIG. 1 in detail. Referring to FIGS. 1 and 2, the link layer 151/251 may include a sub-event module 310 and an ACK/NACK module (or response module) 320. The ACK/NACK module 320 may include a data check unit 321, a flush point unit 322, and an ACK/NACK management unit 323. In some example embodiments, the link layer 151/251 may determine whether to send the response signal to the outside, based on valid information, data check information, and flush information. For example, the link layer 151/251 may send the response signal in consideration of a result of determining whether to send the response signal.

The sub-event module 310 may determine whether the data or packet received from an external device is valid. The sub-event module 310 may generate valid information indicating whether the received data or packet is valid. The sub-event module 310 may send the valid information to the ACK/NACK module 320.

The data check unit 321 may check whether data to be transmitted exist. For example, when there are CIS data to be transmitted to the outside together with the response signal, the first and second hosts 140 and 240 may send the CIS data to the first and second controllers 150 and 250. In response to the received CIS data, the data check unit 321 may determine whether data to be transmitted to the outside exist. The data check unit 321 may generate data check information indicating whether there are data to be transmitted to the outside. The data check unit 321 may send the data check information to the ACK/NACK management unit (or response management unit) 323.

The flush point unit 322 may determine whether a current sub-event is a sub-event just before a flush point of the received data or packet. The flush point unit 322 may generate flush information indicating whether a current sub-event is a sub-event just before a flush point. The flush point unit 322 may send the flush information to the ACK/NACK management unit 323.

The ACK/NACK management unit 323 may determine whether to send the response signal to the outside. The ACK/NACK management unit 323 may receive the valid information from the sub-event module 310. The ACK/NACK management unit 323 may receive the data check information from the data check unit 321. The ACK/NACK management unit 323 may receive the flush information from the flush point unit 322. The ACK/NACK management unit 323 may determine whether to send the response signal, based on the valid information, the data check information, and the flush information. The ACK/NACK management unit 323 may determine whether there is satisfied a specific condition in which the response signal is not transmitted, based on the valid information, the data check information, and the flush information.

As described above, when the specific condition is satisfied, the ACK/NACK management unit 323 may not send any response signal. That is, because the ACK/NACK management unit 323 does not send a meaningless (or unnecessary) ACK or NACK signal, the energy necessary for transmission (Tx) may be saved. In particular, a use time of a wireless communication device may increase by optimizing the amount of energy consumed in a situation where a communication environment is complicated.

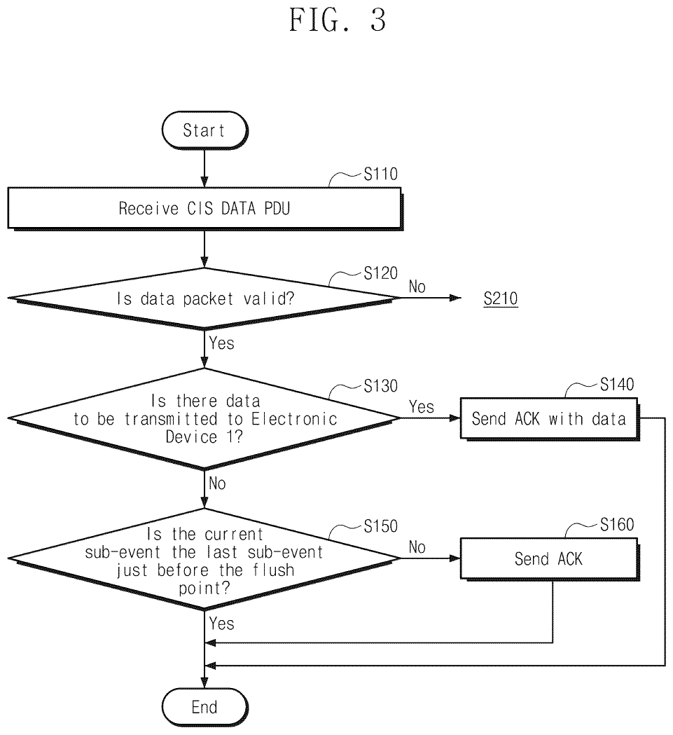

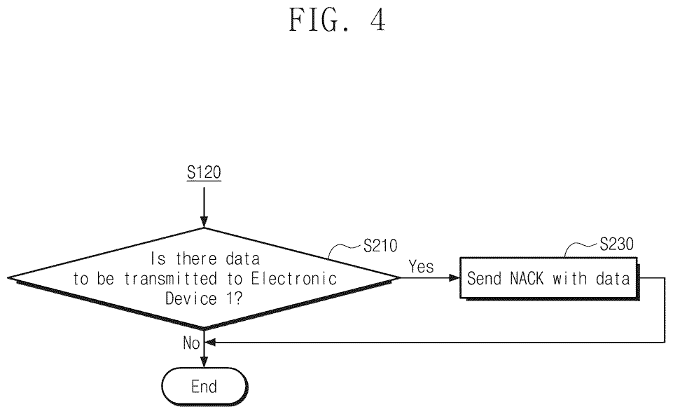

FIGS. 3 and 4 are flowcharts illustrating an example of operations of first and second electronic devices of FIG. 1. Below, for convenience, the description will be given with reference to an example in which the first electronic device 100 sends data or packets to the second electronic device 200 and the second electronic device 200 sends the response signal to the first electronic device 100. However, the present disclosure is not limited thereto. For example, even in the case where the second electronic device 200 sends data or packets to the first electronic device 100 and the first electronic device 100 sends the response signal to the second electronic device 200, the operation may be performed based on the manner to be described below.

Referring to FIGS. 1 and 3, in operation S110, the second electronic device 200 may receive a data packet from the first electronic device 100. For example, the second electronic device 200 may receive the CIS PDU from the first electronic device 100.

In operation S120, the second electronic device 200 may determine whether the received data packet is valid. When the data packet is valid, the second electronic device 200 performs operation S130; when the data packet is invalid, the second electronic device 200 performs operation S210.

In operation S130, the second electronic device 200 may determine whether there are data to be transmitted to the first electronic device 100. For example, the second electronic device 200 may determine whether there are CIS data to be transmitted to the first electronic device 100. When data to be transmitted to the first electronic device 100 exist, the second electronic device 200 performs operation S140; when data to be transmitted to the first electronic device 100 do not exist, the second electronic device 200 performs operation S150.

In operation S140, the second electronic device 200 may send the response signal (or ACK signal) to the first electronic device 100 together with data. Because the data packet provided from the first electronic device 100 is valid, the second electronic device 200 may send the ACK signal. That is, in response to the valid data packet, the second electronic device 200 may send the ACK signal. Because data to be transmitted to the first electronic device 100 exist, the second electronic device 200 may send the ACK signal including the data to the first electronic device 100.

In operation S150, the second electronic device 200 may determine whether a current sub-event is the last sub-event just before the flush point. When the current sub-event is not the last sub-event just before the flush point, the second electronic device 200 performs operation S160; when the current sub-event is the last sub-event just before the flush point, the second electronic device 200 may not perform operation S160.

In other words, when the current sub-event is the last sub-event just before the flush point, the second electronic device 200 may not send the ACK signal to the first electronic device 100. After the current sub-event, the flush point of the data packet received from the first electronic device 100 arrives. As such, even though the second electronic device 200 does not send the ACK signal to the first electronic device 100, the first electronic device 100 sends a next data packet. That is, regardless of whether the second electronic device 200 sends the ACK signal to the first electronic device 100, the first electronic device 100 may send a next data packet to the second electronic device 200. To reduce power consumption, the second electronic device 200 may not send the ACK signal to the first electronic device 100 in the last sub-event just before the flush point.

In operation S160, the second electronic device 200 may send the ACK signal to the first electronic device 100. Because the current sub-event is not the last sub-event just before the flush point of the received data packet, the second electronic device 200 may send the ACK signal to the first electronic device 100. In response to the ACK signal, the first electronic device 100 may send a next data packet without resending the data packet.

Referring to FIG. 4, when the data packet received from the first electronic device 100 is invalid, the second electronic device 200 performs operation S210.

In operation S210, the second electronic device 200 may determine whether there are data to be transmitted to the first electronic device 100. For example, the second electronic device 200 may determine whether there are CIS data to be transmitted to the first electronic device 100. When data to be transmitted to the first electronic device 100 exist, the second electronic device 200 performs operation S230; when data to be transmitted to the first electronic device 100 do not exist, the second electronic device 200 may not performs operation S230.

In other words, because the received data packet is invalid and data to be transmitted to the first electronic device 100 does not exist, the second electronic device 200 may not send the NACK signal. When the first electronic device 100 fails to receive the ACK signal, the first electronic device 100 may resend the data packet. Alternatively, the first electronic device 100 may resend the CIS PDU until the ACK signal is received or until the flush point of the CIS PDU. Accordingly, even though the second electronic device 200 does not send the NACK signal to the first electronic device 100, the first electronic device 100 may resend the data packet. To reduce power consumption, the second electronic device 200 may not send the NACK signal to the first electronic device 100 in response to an invalid data packet. The first electronic device 100 may receive the ACK signal or may resend the data packet to the second electronic device 200 until the flush point of the data packet.

In operation S230, the second electronic device 200 may send the NACK signal to the first electronic device 100 together with the data. Because the data packet provided from the first electronic device 100 is invalid and data to be transmitted to the first electronic device 100 exists, the second electronic device 200 may send the NACK signal. That is, based on the invalid data packet and the data to be transmitted to the first electronic device 100, the second electronic device 200 may send the NACK signal including the data to the first electronic device 100.

As described with reference to FIGS. 3 and 4, to optimize energy consumption, the second electronic device 200 may not send the ACK/NACK signal. Table 1 below shows a pseudo code of an ACK/NACK transmission algorithm that the second electronic device 200 is capable of executing. Depending on the ACK/NACK transmission algorithm shown in Table 1, the second electronic device 200 may send the ACK/NACK signal or may not send the ACK/NACK signal.

TABLE 1

Input; CIS subevent from Central to Peripheral (cisC2P), CIS
subevent (data) to Peripheral to Central (cisP2C)
Output; ACK, ACK with CIS data (AD), or NACK with CIS data (ND)
Initialize; Send(CIS data) = send CIS subevent including CIS data.
Mute( ) = do not send CIS subevent (ACK/NACK),
checkSubeventValid(CIS subevent) = check validation of CIS
subevent (VALID; return True, INVALID; return False),
checkCisDataExist( ) = check existence of CIS
subevent (data) to transmit (EXIST; return
remained number of cisP2C, NEXIST; return 0)
checkFlushPoint(CIS subevent) = check CIS
subevent is the last subevent before the flush
point (LAST; return True, Not LAST return False).
In each CIS subevent;
if checkSubevent Valid(cisC2P) is True;
if cisP2C = checkCisDataExist( ) is larger than 0;
Send(AD);
if cisP2C = checkCisDataExist( ) is 0;
if checkFlushPoint(cisC2P) is False;
Send(ACK);
else;
Mute ( );
end
end
if checkSubeventValid(cisC2P) is False;
if cisP2C = checkCisDataExist( ) is larger than 0;
Send(ND);
else;
Mute( );
end
end
end

Some example embodiments are described based on the second electronic device 200 as above, but the present disclosure is not limited thereto. For example, in operation S110, the first electronic device 100 may receive the data packet from the second electronic device 200. In operation S120, the first electronic device 100 may determine whether the received data packet is valid. When the data packet is valid, the first electronic device 100 performs operation S130; when the data packet is invalid, the first electronic device 100 performs operation S210. In operation S130, the first electronic device 100 may determine whether there are data to be transmitted to the second electronic device 200 together with the response signal. When data to be transmitted to the second electronic device 200 exist, the first electronic device 100 performs operation S140; when data to be transmitted to the second electronic device 200 do not exist, the first electronic device 100 performs operation S150. In operation S140, the first electronic device 100 may send the ACK signal to the second electronic device 200 together with the data.

In operation S150, the first electronic device 100 may determine whether a current sub-event is the last sub-event just before the flush point. When the current sub-event is not the last sub-event just before the flush point, the first electronic device 100 performs operation S160; when the current sub-event is the last sub-event just before the flush point, the first electronic device 100 may not perform operation S160. In operation S160, the first electronic device 100 may send the ACK signal to the second electronic device 200.

In operation S210, the first electronic device 100 may determine whether there are data to be transmitted to the second electronic device 200. When there are data to be transmitted to the second electronic device 200 together with the response signal, the first electronic device 100 performs operation S230; when there are no data to be transmitted to the second electronic device 200 together with the response signal, the first electronic device 100 may not perform operation S230. In operation S230, the first electronic device 100 may send the NACK signal to the second electronic device 200 together with the data.

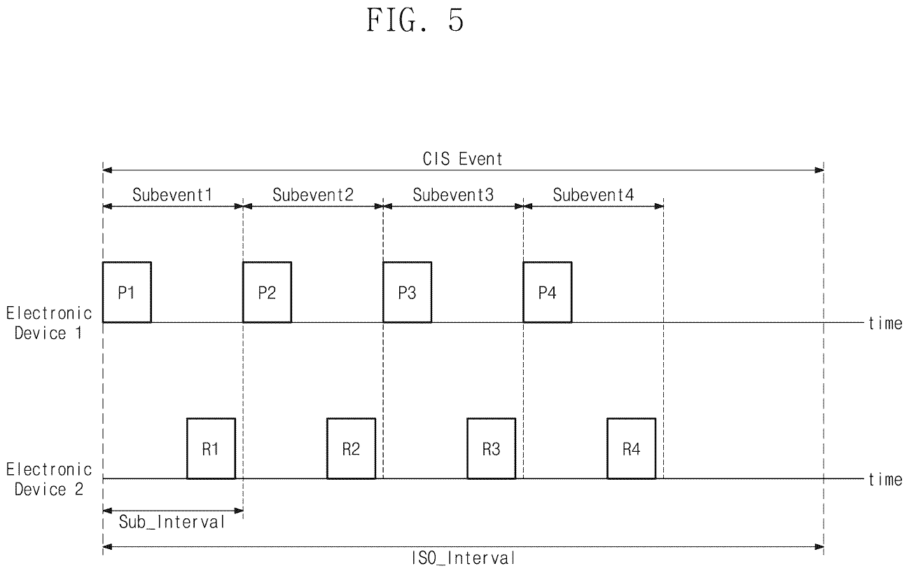

FIG. 5 is a diagram illustrating an example of a method in which a wireless communication system of FIG. 1 sends/receives data. Referring to FIGS. 1 and 5, the isochronous connection may be used to send isochronous data between the first electronic device 100 and the second electronic device 200 by using the connected isochronous stream CIS.

In some example embodiments, the first electronic device 100 and the second electronic device 200 may exchange the CIS parameter and may synchronize a time based on the CIS parameter. The second electronic device 200 may determine whether to send the response signal to the first electronic device 100, based on the CIS parameter. For example, the CIS parameter may include an isochronous interval ISO_Interval, a sub interval Sub_Interval, a sub length SE_Length, a maximum PDU Max_PDU, a maximum SDU Max_SDU, an MPT_C, an MPT_P, the maximum number of sub-events NSE, the number of bursts BN, and a flush timeout FT.

The CIS may be composed of CIS events that occur every isochronous interval ISO_Interval. All the CIS events may be composed of one or more sub-events. In each sub-event, the first electronic device 100 may send one packet (or the CIS PDU) to the second electronic device 200, and the second electronic device 200 may send a response to the first electronic device 100.

Below, for convenience of description, it is assumed that the maximum number of subevents for each CIS event is “4”. However, the present disclosure is not limited thereto.

The CIS event may occur every isochronous interval ISO_Interval, and the sub-event Subevent may occur every sub interval Sub_Interval. The isochronous interval ISO_Interval may indicate a time of the CIS event. Alternatively, the isochronous interval ISO_Interval may indicate a time between two continuous CIS anchor time points (or CIS anchor points).

The sub interval Sub_Interval may indicate a time of the sub-event Subevent. Alternatively, the sub interval Sub_Interval may indicate a time between starts of two continuous sub-events. For example, the sub interval Sub_Interval may indicate a time from a point in time when a first sub-event Subevent1 starts to a point in time when a second sub-event Subevent2 starts.

For example, the CIS event may include first to fourth sub-events Subevent1 to Subevent4. In the first sub-event Subevent1, the first electronic device 100 may send a first data packet P1, and the second electronic device 200 may send a first response R1. In the second sub-event Subevent2, the first electronic device 100 may send a second data packet P2, and the second electronic device 200 may send a second response R2. In the third sub-event Subevent3, the first electronic device 100 may send a third data packet P3, and the second electronic device 200 may send a third response R3. In the fourth sub-event Subevent4, the first electronic device 100 may send a fourth data packet P4, and the second electronic device 200 may send a fourth response R4.

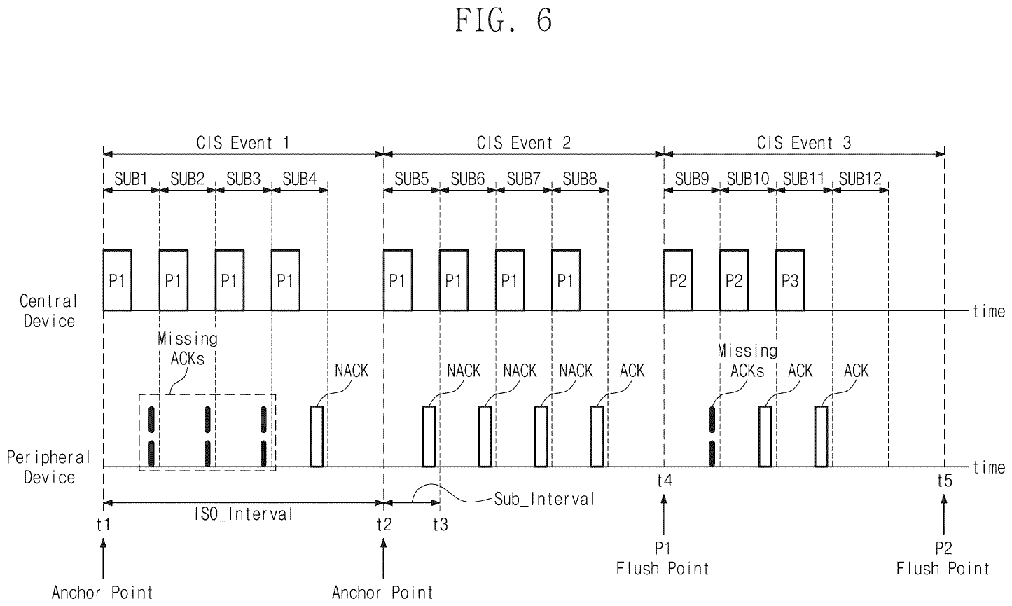

FIG. 6 is a diagram illustrating an example of an operation method of a wireless communication system. Referring to FIG. 6, a central device may send first to third data packets P1 to P3 to a peripheral device through first to third CIS events CIS Event1 to CIS Event3. The first CIS event CIS Event1 may include first to fourth sub-events SUB1 to SUB4, the second CIS event CIS Event2 may include fifth to eighth sub-events SUB5 to SUB8, and the third CIS event CIS Event3 may include ninth to twelfth sub-events SUB9 to SUB 12.

A first time point t1 may be an anchor point, a second time point t2 may be an anchor point, a fourth time point t4 may be a flush point of the first packet P1, and a fifth time point t5 may be a flush point of the second packet P2. Synchronization for a start point of a sub-event may be performed based on the anchor point. For example, the start point of the first sub-event SUB1 may be synchronized with the first time point t1 being the anchor point, and the start point of the fifth sub-event SUB5 may be synchronized with the second time point t2 being the anchor point.

As described with reference to FIG. 5, the isochronous interval ISO_Interval may indicate a time between two continuous CIS anchor time points (or CIS anchor points). That is, the isochronous interval ISO_Interval may indicate a time from the first time point t1 to the second time point t2. The sub interval Sub_Interval may indicate a time between starts of two continuous sub-events. That is, the sub interval Sub_Interval may indicate a time from the second time point t2 to the third time point t3.

Below, for convenience of description, it is assumed that in each CIS event, the maximum number of sub-events NSE is “4”, the flush timeout FT is “2”, and the number of bursts BN is “1”. However, the present disclosure is not limited thereto.

The flush timeout FT may be defined as the maximum number of isochronous intervals ISO_Interval in which the CIS PDU is capable of being transmitted (or retransmitted). The number of bursts that is one of values in the CIS parameter may be defined as the maximum number of packets that are transmitted in the isochronous interval ISO_Interval.

In the first CIS event CIS Event1, the central device may send a plurality of first packets P1 to the peripheral device. In the first sub-event SUB1, the central device may send the first packet P1 to the peripheral device, and the ACK signal may be lost (or may disappear) during the transfer. Even though the peripheral device sends the ACK signal to the central device, the ACK signal may be lost during the transfer. Alternatively, the NACK signal may be lost during the transfer (not illustrated). As such, the central device may fail to receive any response signal (e.g., the ACK signal or the NACK signal).

The central device may resend the first packet P1 until the flush point of the first packet P1 or until the ACK signal is received. In the second sub-event SUB2, the central device may send the first packet P1 to the peripheral device, and the ACK signal may be lost during the transfer. In the third sub-event SUB3, the central device may send the first packet P1 to the peripheral device, and the ACK signal may be lost during the transfer.

In the fourth sub-event SUB4, the central device may send the first packet P1 to the peripheral device and may receive the NACK signal from the peripheral device. The peripheral device may receive the first packet P1 being invalid. The peripheral device may send the NACK signal to the central device in response to the first packet P1 being invalid. The peripheral device may send the NACK signal and may wait for the retransmission of the first packet P1 from the central device.

In the fifth sub-event SUB5, the central device may send the first packet P1 to the peripheral device and may receive the NACK signal from the peripheral device. The peripheral device may send the NACK signal to the central device in response to the first packet P1 being invalid. In the sixth sub-event SUB6, the central device may send the first packet P1 to the peripheral device and may receive the NACK signal from the peripheral device. The peripheral device may send the NACK signal to the central device in response to the first packet P1 being invalid.

In the seventh sub-event SUB7, the central device may send the first packet P1 to the peripheral device and may receive the NACK signal from the peripheral device. The peripheral device may send the NACK signal to the central device in response to the first packet P1 being invalid. In the eighth sub-event SUB8, the central device may send the first packet P1 to the peripheral device and may receive the ACK signal from the peripheral device.

In the ninth sub-event SUB9, the central device may send the second packet P2 to the peripheral device, and the ACK signal may be lost during the transfer. In the tenth sub-event SUB10, the central device may send the second packet P2 to the peripheral device and may receive the ACK signal from the peripheral device. In the eleventh sub-event SUB11, the central device may send the third packet P3 to the peripheral device and may receive the ACK signal from the peripheral device. In the twelfth sub-event SUB12, the central device may not send any packet to the peripheral device. The peripheral device may also not respond.

As described above, when a packet received from the central device is invalid, the peripheral device may send the NACK signal. When the packet received from the central device is valid, the peripheral device may send the ACK signal. When the received packet is valid, the peripheral device may send the ACK signal regardless of the current sub-event and the flush point.

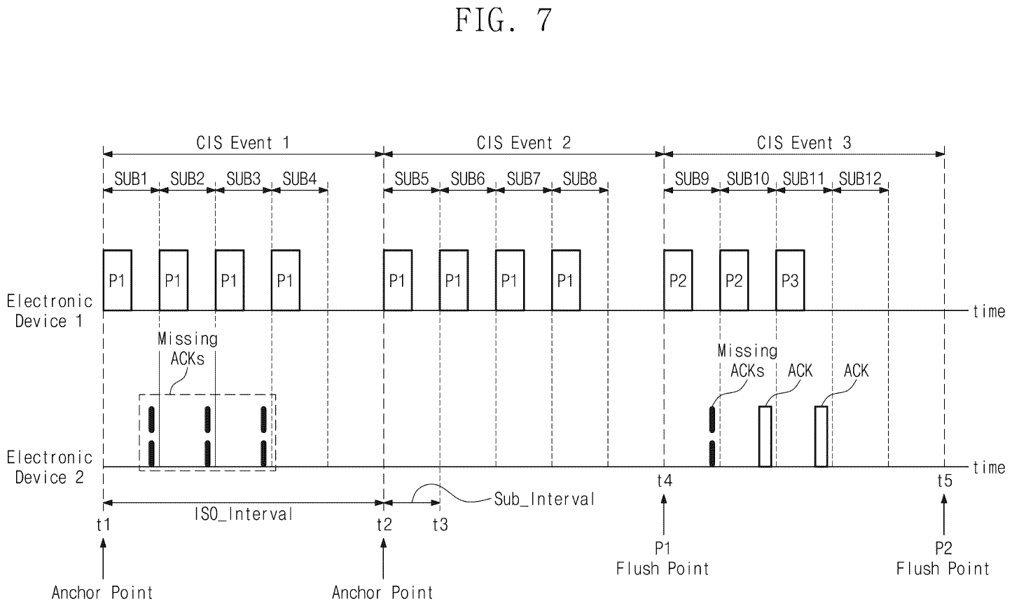

FIG. 7 is a diagram illustrating an example of an operation method of a wireless communication system of FIG. 1. For convenience of description, additional description associated with the components described with reference to FIG. 6 will be omitted to avoid redundancy. Referring to FIGS. 1 and 7, in the first sub-event SUB1, the first electronic device 100 may send the first packet P1 to the second electronic device 200, and the ACK signal may be lost during the transfer. In the second sub-event SUB2, the first electronic device 100 may send the first packet P1 to the second electronic device 200, and the ACK signal may be lost during the transfer. In the third sub-event SUB3, the first electronic device 100 may send the first packet P1 to the second electronic device 200, and the ACK signal may be lost during the transfer. That is, in the first to third sub-events SUB1 to SUB3, the ACK signal may be lost during the transfer. Alternatively, in the first to third sub-events SUB1 to SUB3, the NACK signal may be lost during the transfer (not illustrated). In other words, in the first to third sub-events SUB1 to SUB3, the first electronic device 100 may fail to receive any response signal.

In the fourth sub-event SUB4, the first electronic device 100 may send the first packet P1 to the second electronic device 200. The second electronic device 200 may receive the first packet P1 being invalid. The second electronic device 200 may not send the NACK signal to the first electronic device 100 in response to the first packet P1 being invalid. The first electronic device 100 may fail to receive any response signal.

Referring to FIG. 6, in the fourth sub-event SUB4, the peripheral device may send the NACK signal in response to the first packet P1 being invalid. In contrast, referring to FIG. 7, in the fourth sub-event SUB4, the second electronic device 200 may not send the NACK signal to the first electronic device 100 in response to the first packet P1 being invalid. The second electronic device 200 may not send any response signal to the first electronic device 100. Even though the second electronic device 200 does not send the NACK signal to the first electronic device 100, the first electronic device 100 may recognize that there is a need to again send the first packet P1 to the second electronic device 200. As such, to reduce power consumption, the second electronic device 200 may not send the NACK signal to the first electronic device 100.

In the fifth sub-event SUB5, the first electronic device 100 may send the first packet P1 to the second electronic device 200. The second electronic device 200 may receive the first packet P1 being invalid. The second electronic device 200 may not send the NACK signal to the first electronic device 100 in response to the first packet P1 being invalid. The first electronic device 100 may fail to receive any response signal.

In the sixth sub-event SUB6, the first electronic device 100 may send the first packet P1 to the second electronic device 200. The second electronic device 200 may receive the first packet P1 being invalid. The second electronic device 200 may not send the NACK signal to the first electronic device 100 in response to the first packet P1 being invalid. The first electronic device 100 may fail to receive any response signal.

In the seventh sub-event SUB7, the first electronic device 100 may send the first packet P1 to the second electronic device 200. The second electronic device 200 may receive the first packet P1 being invalid. The second electronic device 200 may not send the NACK signal to the first electronic device 100 in response to the first packet P1 being invalid. The first electronic device 100 may fail to receive any response signal.

In the eighth sub-event SUB8, the first electronic device 100 may send the first packet P1 to the second electronic device 200. The second electronic device 200 may receive the first packet P1 being valid. The second electronic device 200 may not send the ACK signal to the first electronic device 100 in response to the first packet P1 being valid. The first electronic device 100 may fail to receive any response signal. Even though the first packet P1 received is valid, because the eighth sub-event SUB8 is a sub-event just before the flush point of the first packet P1, the second electronic device 200 may not send the ACK signal to the first electronic device 100.

Referring to FIG. 6, in the eighth sub-event SUB8, the peripheral device may send the ACK signal in response to the first packet P1 being valid. In contrast, referring to FIG. 7, in the eighth sub-event SUB8, the second electronic device 200 may not send the ACK signal to the first electronic device 100 in response to the first packet P1 being valid. The second electronic device 200 may not send any response signal to the first electronic device 100. Even though the second electronic device 200 does not send the ACK signal to the first electronic device 100, the second electronic device 200 may recognize that the first electronic device 100 is going to send the second packet P2 being a next packet of first packet P1 to the second electronic device 200. That is, because the fourth time point t4 is the flush point for the first packet P1, in the ninth sub-event SUB9, the first electronic device 100 may not send the first packet P1 any longer and may recognize that there is a need to send the second packet P2. As such, to reduce power consumption, the second electronic device 200 may not send the ACK signal to the first electronic device 100.

In the ninth sub-event SUB9, the first electronic device 100 may send the second packet P2 to the second electronic device 200, and the ACK signal may be lost during the transfer. In the tenth sub-event SUB10, the first electronic device 100 may send the second packet P2 to the second electronic device 200 and may receive the ACK signal from the second electronic device 200. Because the tenth sub-event SUB10 is not the last sub-event just before the flush point of the second packet P2, the second electronic device 200 may send the ACK signal to the first electronic device 100 in response to the second packet P2 being valid.

In the eleventh sub-event SUB11, the first electronic device 100 may send the third packet P3 to the second electronic device 200 and may receive the ACK signal from the second electronic device 200. Because the eleventh sub-event SUB11 is not the last sub-event just before the flush point of the third packet P3, the second electronic device 200 may send the ACK signal to the first electronic device 100 in response to the third packet P3 being valid. In the twelfth sub-event SUB12, the first electronic device 100 may not send any packet to the second electronic device 200. The second electronic device 200 may not respond to the first electronic device 100.

As described above, the peripheral device sends the ACK signal or the NACK signal in a sub-event. In contrast, when the specific condition is satisfied in a sub-event, the second electronic device 200 according to some example embodiments of the present disclosure may not send any response signal. Even though the second electronic device 200 does not send the NACK signal to the first electronic device 100, through the CIS parameter, the first electronic device 100 may recognize that there is a need to again send the first packet P1 to the second electronic device 200. As such, the second electronic device 200 may not send the NACK signal to the first electronic device 100 in response to an invalid packet.

Even though the second electronic device 200 does not send the ACK signal to the first electronic device 100 in a sub-event just before the flush point, the first electronic device 100 may recognize that there is a need to send a next packet. As such, even though the second electronic device 200 receives a valid packet, the second electronic device 200 may not send the ACK signal to the first electronic device 100 in a sub-event just before the flush point corresponding to the received data packet.

The above embodiments are described under the condition that the first electronic device 100 is or acts as a transmitter (or an audio source device) and the second electronic device 200 is or acts as a receiver (or an audio sink device), but the present disclosure is not limited thereto. For example, the first electronic device 100 may be or act as a receiver, and the second electronic device 200 may be or act as a transmitter; when the specific condition is satisfied, the first electronic device 100 may not send any response signal to the second electronic device 200.

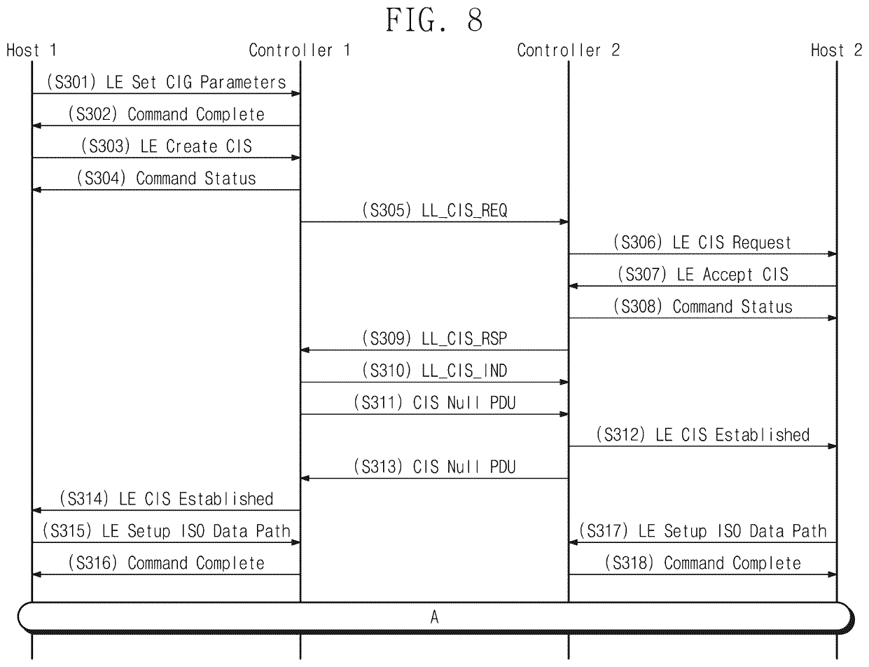

FIGS. 8 to 11 are diagrams illustrating an example of an operation of a wireless communication system of FIG. 1. Referring to FIGS. 1, 8, 9, and 10, in operation S301, the first host 140 may send an “LE Set CIG Parameters” setup command to the first controller 150. In operation S302, the first controller 150 may send a command complete to the first host 140. In operation S303, the first host 140 may send an “LE Create CIS” command to the first controller 150. In operation S304, the first controller 150 may send a command status to the first host 140.

The first controller 150 may perform a CIS create procedure (or process) for creating the CIS between the first electronic device 100 and the second electronic device 200. The first electronic device 100 may start the CIS create procedure by sending a link layer CIS request (LL_CIS_REQ) PDU to the second electronic device 200. In some example embodiments, the first electronic device 100 being the central device may start the CIS create procedure, and the second electronic device 200 being the peripheral device is incapable of starting the CIS create procedure.

In operation S305, the first controller 150 may send the link layer CIS request (LL_CIS_REQ) PDU to the second controller 250. In operation S306, the second controller 250 may send an “LE CIS Request” event to the second host 240. The “LE CIS Request” event may indicate that a controller receives a CIS setup request (e.g., LL_CIS_REQ).

In operation S307, the second host 240 may send an “LE Accept CIS” command to the second controller 250. The “LE Accept CIS” command may be issued after the “LE CIS Request” event. The “LE Accept CIS” command may be used by a host of the peripheral device for the purpose of notifying a controller to accept the request for the identified CIS. In operation S308, the second controller 250 may send the command status to the second host 240.

In operation S309, the second controller 250 may send a link layer CIS response (LL_CIS_RSP) PDU to the first controller 150. In operation S310, the first controller 150 may send a link layer CIS indication (LL_CIS_IND) to the second controller 250. In operation S311, the first controller 150 may send a CIS null PDU to the second controller 250. In operation S312, the second controller 250 may send an “LE CIS Established” event to the second host 240. In operation S313, the second controller 250 may send the CIS null PDU to the first controller 150. In operation S314, the first controller 150 may send the “LE CIS Established” event to the first host 140.

In operation S315, the first host 140 may send an “LE Setup ISO Data Path” command to the first controller 150. In operation S316, the first controller 150 may send the command complete to the first host 140. In operation S317, the second host 240 may send an “LE Setup ISO Data Path” command to the second controller 250. In operation S318, the second controller 250 may send the command complete to the second host 240.

As described above, the first electronic device 100 and the second electronic device 200 may establish the CIS communication through operation S301 to operation S318.

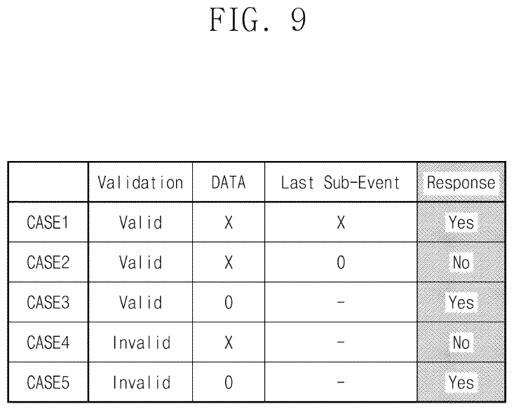

Referring to FIG. 9, it is assumed that CASE1 corresponds to the case where the CIS PDU provided from the first controller 150 is valid, there are no CIS data that the second controller 250 will send to the first controller 150, and a current sub-event is not the last sub-event just before a flush point of a packet (or the CIS PDU) provided from the first controller 150.

It is assumed that CASE2 corresponds to the case where the CIS PDU provided from the first controller 150 is valid, there are no CIS data that the second controller 250 will send to the first controller 150, and a current sub-event is the last sub-event just before a flush point of a packet (or the CIS PDU) provided from the first controller 150.

It is assumed that CASE3 corresponds to the case where the CIS PDU provided from the first controller 150 is valid and there are CIS data that the second controller 250 will send to the first controller 150. It is assumed that CASE3 includes both the case where a current sub-event is the last sub-event just before a flush point of a packet (or the CIS PDU) provided from the first controller 150 and the case where a current sub-event is not the last sub-event just before a flush point of a packet (or the CIS PDU) provided from the first controller 150. That is, it is assumed that whether a current sub-event is the last sub-event just before a flush point of a packet (or the CIS PDU) provided from the first controller 150 is not considered in CASE3.

It is assumed that CASE4 corresponds to the case where the CIS PDU provided from the first controller 150 is invalid and there are no CIS data that the second controller 250 will send to the first controller 150. It is assumed that CASE4 includes both the case where a current sub-event is the last sub-event just before a flush point of a packet (or the CIS PDU) provided from the first controller 150 and the case where a current sub-event is not the last sub-event just before a flush point of a packet (or the CIS PDU) provided from the first controller 150. That is, it is assumed that whether a current sub-event is the last sub-event just before a flush point of a packet (or the CIS PDU) provided from the first controller 150 is not considered in CASE4.

It is assumed that CASE5 corresponds to the case where the CIS PDU provided from the first controller 150 is invalid and there are CIS data that the second controller 250 will send to the first controller 150. It is assumed that CASE5 includes both the case where a current sub-event is the last sub-event just before a flush point of a packet (or the CIS PDU) provided from the first controller 150 and the case where a current sub-event is not the last sub-event just before a flush point of a packet (or the CIS PDU) provided from the first controller 150. That is, it is assumed that whether a current sub-event is the last sub-event just before a flush point of a packet (or the CIS PDU) provided from the first controller 150 is not considered in CASE5.

In CASE1, CASE3, and CASE5, the second electronic device 200 may send the response signal to the first electronic device 100. For example, in CASE1, the second electronic device 200 may send the ACK signal to the first electronic device 100. In CASE3, the second electronic device 200 may send the ACK signal to the first electronic device 100 together with the data. In CASE5, the second electronic device 200 may send the NACK signal to the first electronic device 100 together with the data.

In CASE2 and CASE4, the second electronic device 200 may not send any response signal to the first electronic device 100. That is, to reduce power consumption, the second electronic device 200 may not send the ACK signal or the NACK signal to the first electronic device 100 when the specific condition is satisfied. The specific condition in which the response signal is not transmitted may include CASE2 and CASE4.

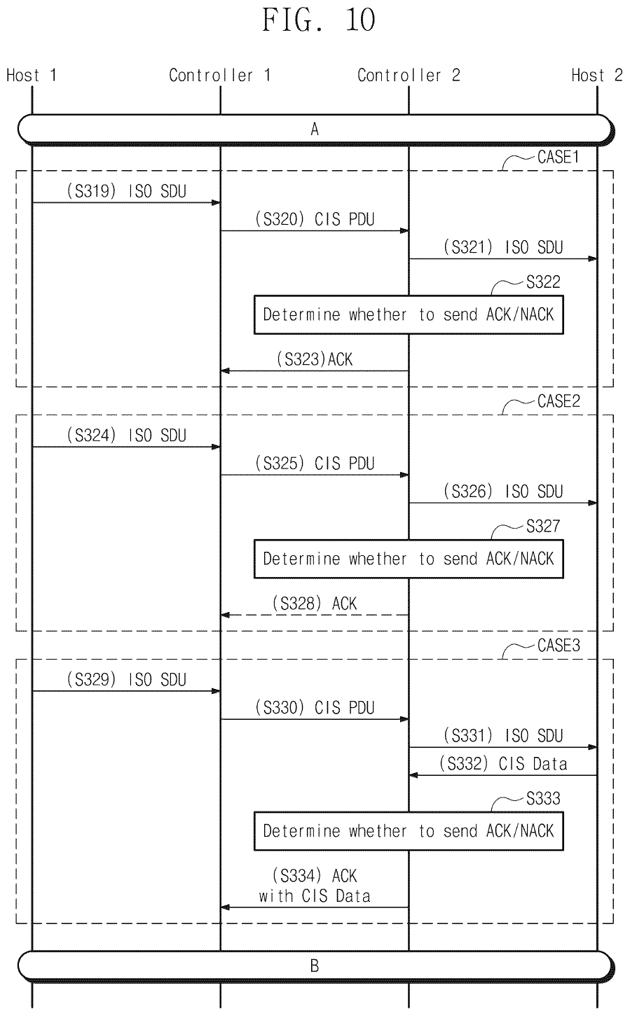

Referring to FIG. 10, CASE1 includes operation S319 to operation S323, CASE2 includes operation S324 to operation S328, and CASE3 includes operation S329 to operation S334. The case where the second controller 250 sends the ACK signal and the case where the second controller 250 does not send the ACK signal will be described with reference to FIG. 10.

In operation S319, the first host 140 may send an ISO service data unit (SDU) to the first controller 150. For example, the first host 140 may send an audio ISO SDU to the first controller 150. In operation S320, the first controller 150 may send the CIS PDU to the second controller 250. The first controller 150 may convert the ISO SDU into the CIS PDU. The first controller 150 may convert the ISO SDU into one or plural CIS PDUs. The first controller 150 may send the converted CIS PDU to the second controller 250. Alternatively, the first controller 150 may send the plurality of CIS PDUs to the second controller 250.

In operation S321, the second controller 250 may send the ISO SDU to the second host 240. For example, the second controller 250 may convert the received CIS PDU into the ISO SDU. Alternatively, the second controller 250 may convert the plurality of CIS PDUs thus received into the ISO SDU.

In operation S322, the second controller 250 may determine whether to send the ACK/NACK signal to the first controller 150. That is, the second controller 250 may determine whether there is satisfied the specific condition in which the response signal is not transmitted. In some example embodiments, the second controller 250 may determine whether a data packet is valid. When the data packet is valid, the second controller 250 may determine whether there are data to be transmitted to the first electronic device 100. The second controller 250 may determine whether a current sub-event is the last sub-event just before a flush point of the received CIS PDU.

For example, the sub-event module 310 may determine whether the received CIS PDU is valid. The data check unit 321 may determine whether data to be transmitted to the first electronic device 100 exist. The flush point unit 322 may determine whether the current sub-event is the last sub-event just before the flush point. The ACK/NACK management unit 323 may determine whether there is satisfied a specific condition in which the response signal is not transmitted, based on the valid information, the data check information, and the flush information, etc.

Because the CIS PDU provided from the first controller 150 is valid, there are no CIS data that the second controller 250 will send to the first controller 150, and the current sub-event is not the last sub-event just before the flush point of the packet (or the CIS PDU) provided from the first controller 150 (i.e., in CASE1), the second controller 250 may determine to send the ACK signal to the first controller 150. In operation S323, the second controller 250 may send the ACK signal to the first controller 150.

In operation S324, the first host 140 may send the ISO SDU to the first controller 150. In operation S325, the first controller 150 may send the CIS PDU to the second controller 250. In operation S326, the second controller 250 may send the ISO SDU to the second host 240. In operation S327, the second controller 250 may determine whether to send the ACK/NACK signal to the first controller 150. Because the CIS PDU provided from the first controller 150 is valid, there are no CIS data that the second controller 250 will send to the first controller 150, and the current sub-event is the last sub-event just before the flush point of the packet (or the CIS PDU) provided from the first controller 150 (i.e., in CASE2), the second controller 250 may determine to send no ACK signal to the first controller 150. In operation S328, the second controller 250 may not send the ACK signal to the first controller 150, the dashed line representing a signal has not been sent. The second controller 250 may keep silent in response to the CIS PDU received from the first controller 150.

In operation S329, the first host 140 may send the ISO SDU to the first controller 150. In operation S330, the first controller 150 may send the CIS PDU to the second controller 250. In operation S331, the second controller 250 may send the ISO SDU to the second host 240. In operation S332, the second host 240 may send the CIS data to the second controller 250. In operation S333, the second controller 250 may determine whether to send the ACK/NACK signal to the first controller 150. Because the CIS PDU provided from the first controller 150 is valid and there are CIS data that the second controller 250 will send to the first controller 150 (i.e., in CASE3), regardless of whether the current sub-event is the last sub-event just before the flush point, the second controller 250 may determine to send ACK signal to the first controller 150. In operation S334, the second controller 250 may send the ACK signal to the first controller 150 together with the CIS data.

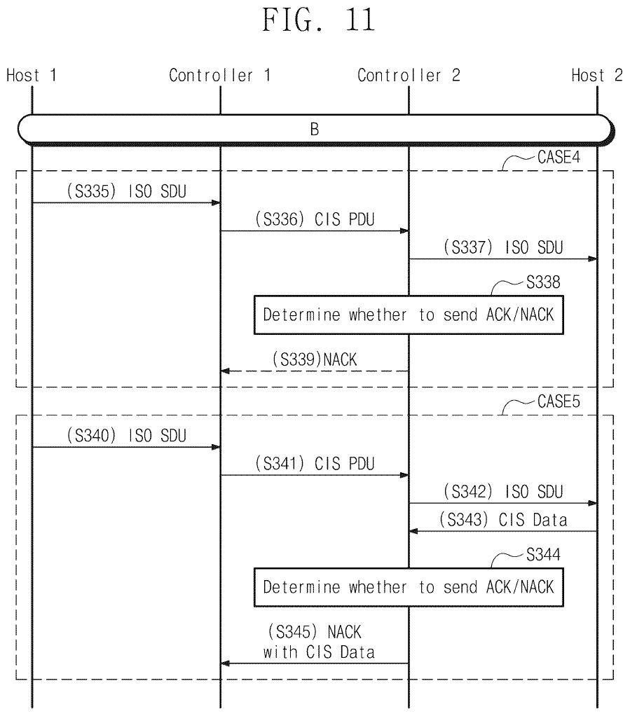

Referring to FIG. 11, CASE4 includes operation S335 to operation S339, and CASE5 includes operation S340 to operation S345. The case where the second controller 250 sends the NACK signal and the case where the second controller 250 does not send the NACK signal will be described with reference to FIG. 11.

In operation S335, the first host 140 may send the ISO SDU to the first controller 150. In operation S336, the first controller 150 may send the CIS PDU to the second controller 250. In operation S337, the second controller 250 may send the ISO SDU to the second host 240.

In operation S338, the second controller 250 may determine whether to send the ACK/NACK signal to the first controller 150. In some example embodiments, the second controller 250 may determine whether there are data to be transmitted to the first controller 150.

For example, because the CIS PDU provided from the first controller 150 is invalid and there are no CIS data that the second controller 250 will send to the first controller 150 (i.e., in CASE4), regardless of whether the current sub-event is the last sub-event just before the flush point, the second controller 250 may determine to send no NACK signal to the first controller 150. In operation S339, the second controller 250 may not send the NACK signal to the first controller 150, the dashed line representing a signal has not been sent. That is, the second controller 250 may keep silent in response to the CIS PDU being invalid.

In operation S340, the first host 140 may send the ISO SDU to the first controller 150. In operation S341, the first controller 150 may send the CIS PDU to the second controller 250. In operation S342, the second controller 250 may send the ISO SDU to the second host 240. In operation S343, the second host 240 may send the CIS data to the second controller 250. In operation S344, the second controller 250 may determine whether to send the ACK/NACK signal to the first controller 150. Because the CIS PDU provided from the first controller 150 is invalid and there are CIS data that the second controller 250 will send to the first controller 150 (i.e., in CASE5), regardless of whether the current sub-event is the last sub-event just before the flush point, the second controller 250 may determine to send the NACK signal to the first controller 150. In operation S345, the second controller 250 may send the NACK signal to the first controller 150 together with the CIS data.

As described above, when the specific condition is satisfied (e.g., in CASE2 and CASE4), the second electronic device 200 may not send any response signal to the first electronic device 100. As such, the wireless communication system 10 may optimize the transmission of the NACK signal and operation of the system. In an environment where a flush time is long (or an interval between flush points is long) and a communication situation is bad (e.g., a public transport environment), the wireless communication system 10 may reduce the number of times of transmission of the NACK signal.

The wireless communication system 10 may optimize the transmission of the ACK signal and operation of the system. In an environment where a flush time is short (or an interval between flush points is short) and a communication situation is bad (e.g., a public transport environment), the wireless communication system 10 may reduce the number of times of transmission of the ACK signal. RF energy that is consumed in transmission may be decreased by reducing the number of times of transmission of the NACK signal and the number of times of transmission of the ACK signal. As such, a working time of a receiver (e.g., an audio sink device) in the wireless communication system 10 may increase.

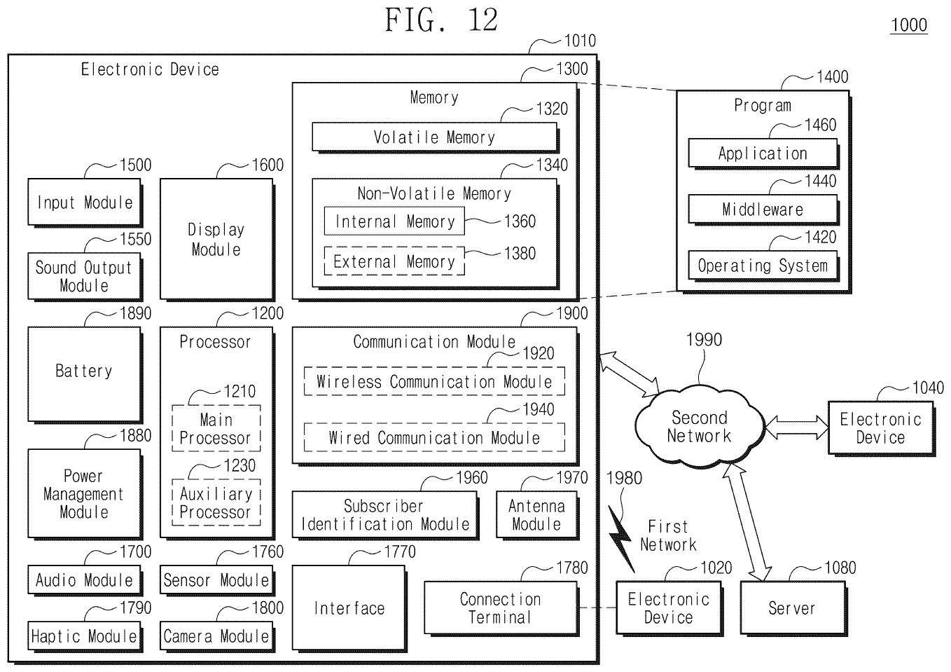

FIG. 12 is a block diagram of an electronic device in a network environment according to some example embodiments. Referring to FIG. 12, an electronic device 1010 in a network environment 1000 may communicate with an electronic device 1020 over a first network 1980 (e.g., a short-range wireless communication network) or may communicate with an electronic device 1040 and/or a server 1080 over a second network 1990 (e.g., a long-range wireless communication network). According to some example embodiments, the electronic device 1010 may communicate with the electronic device 1040 through the server 1080.

According to some example embodiments, the electronic device 1010 may correspond to the first electronic device 100 of FIG. 1, and the electronic device 1020 may correspond to the second electronic device 200 of FIG. 1. The electronic devices 1010 and 1020 may operate based on the manner described with reference to FIGS. 1 to 10.

According to some example embodiments, the electronic device 1010 may include a processor 1200, a memory 1300, an input module 1500, a sound output module 1550, a display module 1600, an audio module 1700, a sensor module 1760, an interface 1770, a connection terminal 1780, a haptic module 1790, a camera module 1800, a power management module 1880, a battery 1890, a communication module 1900, a subscriber identification module 1960, and/or an antenna module 1970. In some example embodiments, the electronic device 1010 may not include at least one (e.g., the connection terminal 1780) of the above components or may further include one or more other components. In some example embodiments, some (e.g., the sensor module 1760, the camera module 1800, and/or the antenna module 1970) of the above components may be integrated into one component (e.g., the display module 1600).

The processor 1200 may execute, for example, software (e.g., a program 1400) to control at least another component (e.g., a hardware or software component) of the electronic device 1010 connected with the processor 1200 and may perform various data processing or operations. According to some example embodiments, as at least a part of the data processing or operations, the processor 1200 may store a command or data received from any other component (e.g., the sensor module 1760 or the communication module 1900) in a volatile memory 1320, may process the command or data stored in the volatile memory 1320, and may store the processed data in a non-volatile memory 1340.

According to some example embodiments, the processor 1200 may include a main processor 1210 (e.g., a central processing unit and/or an application processor) or an auxiliary processor 1230 (e.g., a graphic processing device, a neural processing unit (NPU), an image signal processor, a sensor hub processor, or a communication processor) that is able to operate independently of the main processor 1210 or together with the main processor 1210. For example, when the electronic device 1010 includes the main processor 1210 and the auxiliary processor 1230, the auxiliary processor 1230 may be configured to use a lower power than the main processor 1210 or to be specialized for a specified function. The auxiliary processor 1230 may be implemented separately from the main processor 1210 or may be implemented as a part of the main processor 1210.

The auxiliary processor 1230 may control at least a part of functions or states associated with at least one component (e.g., the display module 1600, the sensor module 1760, or the communication module 1900) of the electronic device 1010, for example, instead of the main processor 1210 while the main processor 1210 is in an inactive (e.g., sleep) state or together with the main processor 1210 while the main processor 1210 is in an active (e.g., application execution) state. According to some example embodiments, the auxiliary processor 1230 (e.g., an image signal processor or a communication processor) may be implemented as a part of any other component (e.g., the camera module 1800 or the communication module 1900) that is functionally associated with the auxiliary processor 1230. According to some example embodiments, the auxiliary processor 1230 (e.g., a neural network processing device) may include a hardware structure specialized for processing of an artificial intelligence (AI) model. The artificial intelligence models may be created through machine learning. The learning may be performed, for example, internally by the electronic device 1010 where the artificial intelligence is performed or may be performed through a separate server (e.g., the server 1080). The learning algorithm may include, for example, supervised learning, unsupervised learning, semi-supervised learning, or reinforcement learning, but the present disclosure is not limited to the above example. The artificial intelligence model may include a plurality of artificial neural network layers. The artificial neural network may include one of a deep neural network (DNN), a convolutional neural network (CNN), a recurrent neural network (RNN), a restricted boltzmann machine (RBM), a deep belief network (DBN), a bidirectional recurrent deep neural network (BRDNN), a deep Q-network, or a combination of two or more thereof, but the present disclosure is not limited thereto. Additionally, or alternatively, the artificial intelligence model may include a software structure in addition to the hardware structure.

The memory 1300 may store various data that are used by at least one component (e.g., the processor 1200 or the sensor module 1760) of the electronic device 1010. The data may include, for example, software (e.g., the program 1400), and input data or output data associated with a command of the software. The memory 1300 may include the volatile memory 1320 or the non-volatile memory 1340.

The program 1400 may be stored in the memory 1300 as software, and may include, for example, an operating system 1420, a middleware 1440, or an application 1460.

The input module 1500 may receive a command or data, which a component (e.g., the processor 1200) of the electronic device 1010 will use, from the outside (e.g., a user) of the electronic device 1010. The input module 1500 may include, for example, a microphone, a mouse, a keyboard, a key (e.g., a button), or a digital pen (e.g., a stylus pen).

The sound output module 1550 may output a sound signal to the outside of the electronic device 1010. The sound output module 1550 may include, for example, a speaker or a receiver. The speaker may be used for a general purpose such as multimedia playback or recording playback. The receiver may be used to receive an incoming call. According to some example embodiments, the receiver may be implemented separated from the speaker or may be implemented as a part of the speaker.

The display module 1600 may visually provide information to the outside (e.g., the user) of the electronic device 1010. The display module 1600 may include, for example, a display, a hologram device, or a projector and a control circuit for controlling a corresponding device. According to some example embodiments, the display module 1600 may include a touch sensor configured to sense a touch or a pressure sensor configured to measure the strength of force generated by the touch.

The audio module 1700 may convert sound to an electrical signal, or reversely, may convert an electrical signal to sound. According to some example embodiments, the audio module 1700 may obtain the sound through the input module 1500 or may output the sound through the sound output module 1550 or through an external electronic device (e.g., the electronic device 1020 (e.g., a speaker or a headphone)) directly or wirelessly connected with the electronic device 1010.

The sensor module 1760 may sense an operation state (e.g., a power or a temperature) of the electronic device 1010 or an external environment state (e.g., a user state) and may generate an electrical signal or a data value corresponding to the sensed state. According to some example embodiments, the sensor module 1760 may include, for example, a gesture sensor, a gyro sensor, a barometric pressure sensor, a magnetic sensor, an acceleration sensor, a grip sensor, a proximity sensor, a color sensor, an infrared (IR) sensor, a biometric sensor, a temperature sensor, a humidity sensor, or an ambient light (or illumination) sensor.

The interface 1770 may support one or more specified protocols that allow the electronic device 1010 to be directly and wirelessly connected with an external electronic device (e.g., the electronic device 1020). According to some example embodiments, the interface 1770 may include, for example, a (high-definition multimedia interface (HDMI), a universal serial bus (USB) interface, an SD card interface, or an audio interface.

The connection terminal 1780 may include a connector that allows the electronic device 1010 to be physically connected with an external electronic device (e.g., the electronic device 1020). According to some example embodiments, the connection terminal 1780 may include, for example, a HDMI connector, a USB connector, an SD card connector, or an audio connector (e.g., a headphone connector).

The haptic module 1790 may convert an electrical signal into a mechanical stimulation (e.g., vibration or movement) or an electrical stimulation, which is perceived by the user through tactile or kinesthetic sensations. According to some example embodiments, the haptic module 1790 may include, for example, a motor, a piezoelectric sensor, or an electrical stimulation device.

The camera module 1800 may photograph a still image and a moving image. According to some example embodiments, the camera module 1800 may include one or more lenses, image sensors, image signal processors, or flashes.

The power management module 1880 may manage the power that is supplied to the electronic device 1010. According to some example embodiments, the power management module 1088 may be implemented, for example, as at least a part of a power management integrated circuit (PMIC).

The battery 1890 may power at least one component of the electronic device 1010. According to some example embodiments, the battery 1890 may include, for example, a primary cell not recharged, a secondary cell rechargeable, or a fuel cell.

The communication module 1900 may establish a direct (or wired) communication channel or a wireless communication channel between the electronic device 1010 and an external electronic device (e.g., the electronic device 1020, the electronic device 1040, or the server 1080) or may perform communication through the established communication channel. The communication module 1900 may include one or more communication processors that operate independently of the processor 1200 (e.g., an application processor) and support direct (e.g., wired) communication or wireless communication. According to some example embodiments, the communication module 1900 may include a wireless communication module 1920 (e.g., a cellular communication module, a short-range wireless communication module, or a global navigation satellite system (GNSS) communication module) or a wired communication module 1940 (e.g., a local area network (LAN) communication module or a power line communication module). A corresponding communication module among the above communication modules may communicate with the external electronic device 1040 over the first network 1980 (e.g., a short-range communication network such as wireless fidelity (Wi-Fi) direct or infrared data association (IrDA)) or the second network 1990 (e.g., a long-range communication network such as a legacy cellular network, a 5G network, a next-generation communication network, an Internet, or a computer network (e.g., LAN or WAN)). The various kinds of communication modules described above may be integrated into one component (e.g., a single chip) or may be implemented with a plurality of components (e.g., a plurality of chips) independent of each other. The wireless communication module 1920 may verify or authenticate the electronic device 1010 within a communication network, such as the first network 1980 or the second network 1990, by using subscriber information (e.g., mobile subscriber identity (IMSI)) stored in the subscriber identification module 1960.

The wireless communication module 1920 may support a 5G network after a 4G network and a next-generation communication technology, such as a new radio (NR) access technology. The NR access technology may support an enhanced mobile broadband (eMBB), massive machine type communications (mMTC), or ultra-reliable and low latency communications (URLLC). The wireless communication module 1920 may support, for example, a high frequency band (e.g., an mmWave band) to implement a high data transfer rate. The wireless communication module 1920 may support various technologies for securing performance in the high frequency band, for example, technologies such as beam-forming, massive multiple-input and multiple-output (MIMO), full dimensional MIMO (FD-MIMO), an array antenna, analog beam-forming, or a large scale antenna. The wireless communication module 1920 may support various requirements specified in the electronic device 1010, an external electronic device (e.g., the electronic device 1040), or a network system (e.g., the second network 1990). According to some example embodiments, the wireless communication module 1920 may support a peak data rate (e.g., 20 Gbps or more) for implementing eMBB, a loss coverage (e.g., 164 dB or less) for implementing mMTC, or a U-plane latency (e.g., a downlink (DL) and an uplink (UL) being 0.5 ms or less or round trip 1 ms or less, respectively) for implementing URLLC.

The antenna module 1970 may transmit a signal or a power to the outside (e.g., an external electronic device) or may receive a signal or a power from the outside. According to some example embodiments, the antenna module 1970 may include an antenna that includes a radiator formed of a conductor or a conductive pattern formed on a substrate (e.g., a PCB). According to some example embodiments, the antenna module 1970 may include a plurality of antennas (e.g., an array antenna). In this case, at least one antenna that is appropriate for a communication manner usable in a communication network such as the first network 1980 or the second network 1990 may be selected from the plurality of antennas, for example, by the communication module 1900. The signal or power may be exchanged between the communication module 1900 and an external electronic device through the selected at least one antenna. According to some example embodiments, in addition to the radiator, any other part (e.g., a radio frequency integrated circuit (RFIC)) may be additionally formed as a part of the antenna module 1970.

According to some example embodiments, the antenna module 1970 may include an mmWave antenna module. According to some example embodiments, the mmWave antenna module may include a printed circuit board, an RFIC that is disposed on a first surface (e.g., a lower surface) of the printed circuit board or adjacent thereto and supports a specified high frequency band (e.g., an mmWave band), and a plurality of antennas (e.g., an array antenna) that are disposed on a second surface (e.g., an upper side or a side surface) of the printed circuit board or adjacent thereto and transmit or receive a signal in the specified high frequency band.

At least some of the above components may be connected with each other through a communication manner (e.g., a general purpose input and output (GPIO), a serial peripheral interface (SPI), and/or a mobile industry processor interface (MIPI)) between peripheral devices and may exchange signals (e.g., commands or data) with each other.

According to some example embodiments, the command or data may be transmitted or received between the electronic device 1010 and the external electronic device 1040 through the server 1080 connected with the second network 1990. A type of the external electronic device 1020 or 1040 may be identical to or different from that of the electronic device 1010. According to some example embodiments, some or all of operations to be performed in the electronic device 1010 may be performed in one or more external electronic devices of the external electronic devices 1020, 1040, and 1080. For example, in the case where the electronic device 1010 should perform any function or service automatically or in response to a request from the user or any other device, the electronic device 1010 may request one or more external electronic devices to perform at least a part of the function or service, instead of internally executing the function or service or additionally. The one or more external electronic devices that receive the request may execute at least a part of the function or service thus requested or an additional function or service associated with the request and may provide a result of the execution to the electronic device 1010. The electronic device 1010 may process the result as it is or additionally and may provide a result of the processing as at least a part of the response to the request. To this end, for example, a cloud computing, distributed computing, mobile edge computing, or client-server computing technology may be used. The electronic device 1010 may provide, for example, an ultra-low latency service by using the distributed computing or the mobile edge computing. In another embodiment, the external electronic device 1040 may include an Internet of Things (IoT) device. The server 1080 may be an intelligent service that uses machine learning and/or a neural network. According to some example embodiments, the external electronic device 1040 or the server 1080 may be included in the second network 1990. The electronic device 1010 may be applied to an intelligent service (e.g., a smart home, a smart city, a smart car, or a health care) based on the 5G communication technology and the IoT-related technology.

According to some example embodiments of the present disclosure, an electronic device may be implemented with various types of devices. The electronic device may include, for example, a portable communication device (e.g., a smartphone), a computer device, a portable multimedia device, a portable medical appliance, a camera, a wearable device, or a home appliance. The electronic device according to some example embodiments of the present disclosure is not limited to the electronic devices described above.

Any or all of the elements described with reference to FIG. 12 may communicate with any or all other elements described with reference to FIG. 12; for example, any element may engage in one-way and/or two-way and/or broadcast communication with any or all other elements in FIG. 12, to transfer and/or exchange information such as but not limited to data and/or commands, in a serial and/or parallel manner, via a wireless and/or a wired bus (not illustrated). Information transferred and/or exchanged may be encoded in an analog and/or a digital manner; example embodiments are not limited thereto.

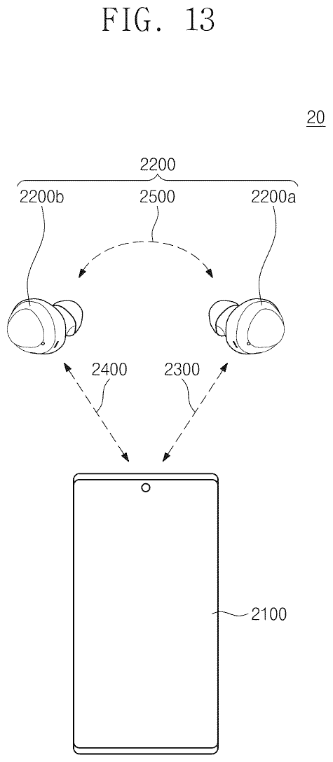

FIG. 13 is a diagram illustrating an electronic device and a wireless audio input/output device according to some example embodiments of the present disclosure. Referring to FIG. 13, according to some example embodiments, an electronic device 2100 may be wirelessly connected with a wireless audio input/output device. The wireless audio input/output device may include an ear wearable device, a wireless earphone, a wireless headset, an ear bud, and a true wireless stereo (TWS) device.

Some example embodiments in which the wireless audio input/output device is an ear wearable device 2200 composed of a pair of first ear device 2200a and second ear device 2200b is illustrated, but the present disclosure is not limited thereto. The wireless audio input/output device may be a single accessory device (e.g., a wireless headset) having microphones at a first location (e.g., toward the right ear) and a second location (e.g., toward the left ear), respectively. The wireless audio input/output device may be a plurality of Internet of Things (IoT) devices, each of which is connected with the electronic device 2100 over a short-range wireless communication network and includes a microphone.

According to some example embodiments, the electronic device 2100 may connect the ear wearable device 2200 (e.g., the first ear device 2200a and the second ear device 2200b) over the short-range wireless communication network (e.g., Bluetooth communication).

Referring to FIG. 1, the wireless communication system 10 includes the first electronic device 100 and the second electronic device 200. In contrast, referring to FIG. 13, a wireless communication system 20 may include the electronic device 2100, the first ear device 2200a, and the second ear device 2200b. The electronic device 2100 may correspond to the first electronic device 100 of FIG. 1, and the first and second ear devices 2200a and 2200b may correspond to the second electronic device 200 of FIG. 1. That is, FIG. 13 shows an example in which the first electronic device 100 establishes wireless communication connection with a plurality of second electronic devices 200. The wireless communication system 20 may perform an operation based on the manner described with reference to FIGS. 1 to 11.

According to some example embodiments, each of the first and second ear devices 2200a and 2200b may be independently connected with the electronic device 2100. For example, the first ear device 2200a may be connected with the electronic device 2100, and the second ear device 2200b may be connected with the electronic device 2100. That is, the electronic device 2100 may be independently connected with the first ear device 2200a and the second ear device 2200b. For example, the first ear device 2200a may connect with the electronic device 2100 over a first communication link (or first transport link) 2300. The second ear device 2200b may be connected with the electronic device 2100 through a second communication link 2400. The first ear device 2200a and the second ear device 2200b may be connected over a third communication link 2500 and may exchange status information with each other.

According to some example embodiments, each of the first and second ear devices 2200a and 2200b may exchange audio packets with the electronic device 2100 over an independent LE link. For example, the first ear device 2200a may operate as a slave, and the electronic device 2100 may operate as a master. Alternatively, the first ear device 2200a may operate as a master, and the electronic device 2100 may operate as a slave. The second ear device 2200b may operate as a slave, and the electronic device 2100 may operate as a master. Alternatively, the second ear device 2200b may operate as a master, and the electronic device 2100 may operate as a slave.

According to some example embodiments, the first ear device 2200a and the second ear device 2200b may receive a control signal from the electronic device 2100 or may perform a function depending on a control signal generated by the first ear device 2200a or the second ear device 2200b. The control signal received from the electronic device 2100 may be a signal associated with at least one of a play function, a call function, a stop function, a volume control function, and a recording function associated with the audio input/output.

According to some example embodiments, the first ear device 2200a and the second ear device 2200b may perform a function of obtaining an audio signal (e.g., an audio packet, a voice signal, or audio data) from the electronic device 2100 and outputting the sound through a speaker. The first ear device 2200a and the second ear device 2200b may perform a function of receiving external sound through a microphone, converting the received sound into an audio signal (or an audio packet), and sending the audio signal to the electronic device 2100.

According to some example embodiments, the electronic device 2100 may receive the audio signal (e.g., a packetized bit stream or packet) (for example, along the first or second communication link 2300 and/or 2400) from the first ear device 2200a or the second ear device 2200b, respectively. The electronic device 2100 may recognize the audio signal transmitted from the first ear device 2200a or the second ear device 2200b as an audio signal transmitted through one ear wearable device 2200.

According to the present disclosure, low-power electronic devices performing short-range wireless communication and operation methods of the electronic devices are provided.

The first electronic device 100 (or other circuitry, for example, second electronic device 200, processor 110, memory 120, communication module 130, processor 210, memory 220, communication module 230, first and second hosts 140/240, first and second controllers 150/250, link layers 151/251, physical layers 152/252, sub-event module 310, ACK/NACK module 320, data check unit 321, flush point unit 322, ACK/NACK management unit 323, electronic device 1010/1020/1040/2100, server 1080, ear devices 2200a/2200b, and various subcomponents thereof (e.g., memory 1300, processor 1200, etc.) as discussed herein) may include hardware including logic circuits; a hardware/software combination such as a processor executing software; or a combination thereof. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc.

While the present disclosure has been described with reference to example embodiments thereof, it will be apparent to those of ordinary skill in the art that various changes and modifications may be made thereto without departing from the spirit and scope of the present disclosure as set forth in the following claims.

What is claimed is:

1. An operation method of an electronic device that performs short-range wireless communication, the method comprising:
receiving a data packet from an outside;
determining whether to send a response signal, based on valid information indicating validation of the received data packet, data check information indicating whether there are data to be transmitted to the outside, and flush information indicating whether a current sub-event is a last sub-event just before a flush point for the received data packet, in response to the received data packet; and
sending the response signal in consideration of a result of the determining whether to send the response signal.

2. The method of claim 1, wherein the determining whether to send the response signal includes:
determining whether the received data packet is valid;
based on the received data packet is valid, determining whether there are the data to be transmitted to the outside; and
based on the received data packet being valid, determining whether the current sub-event is the last sub-event just before the flush point for the received data packet.

3. The method of claim 2, further comprising:
based on the received data packet being valid and there are the data to be transmitted to the outside, sending an ACK signal being a positive response signal together with the data to the outside.

4. The method of claim 3, further comprising:
based on the received data packet being valid, the data to be transmitted to the outside not existing, and the current sub-event being the last sub-event just before the flush point for the received data packet, not sending the ACK signal to the outside; and
based on the received data packet being valid, the data to be transmitted to the outside not existing, and the current sub-event not being the last sub-event just before the flush point for the received data packet, sending the ACK signal to the outside.

5. The method of claim 1, wherein the determining whether to send the response signal includes:
determining whether the received data packet is valid; and
based on the received data packet being invalid, determining whether there are the data to be transmitted to the outside.

6. The method of claim 5, further comprising:
based on the received data packet being invalid and the data to be transmitted to the outside existing, sending a NACK signal being a negative response signal together with the data to the outside; and
based on the received data packet being invalid and the data to be transmitted to the outside not existing, not sending the NACK signal to the outside.

7. The method of claim 1, wherein a short-range wireless communication low energy connected isochronous stream (CIS) is configured to perform the short range wireless communication.

8. The method of claim 1, further comprising:
establishing CIS communication before receiving the data packet from the outside,
wherein the establishing of the CIS communication includes:
receiving a link layer CIS request (LL_CIS_REQ);
sending a link layer CIS response (LL_CIS_REP) to the outside in response to the link layer CIS request;
receiving a link layer CIS indication (LL_CIS_IND); and
receiving a CIS null protocol data unit (PDU).

9. The method of claim 1, wherein
a CIS parameter is exchanged, and a time is synchronized based on the CIS parameter, and
the determining whether to send the response signal includes determining whether to send the response signal based on the CIS parameter.

10. An operation method of an electronic device that communicates with an external device through short-range wireless communication, the method comprising:
receiving a data packet from the external device;
determining whether a specific condition is satisfied in which a response signal is not transmitted, in response to the received data packet; and
based on the specific condition being satisfied, keeping silent without sending the response signal to the external device,
wherein a low energy connected isochronous stream (CIS) is configured to perform the short range wireless communication.

11. The method of claim 10, wherein
the specific condition includes a case where the received data packet is valid, there are no data to be transmitted to the external device, and a current sub-event is a last sub-event just before a flush point for the received data packet, and
based on the specific condition being satisfied, the keeping silent without sending the response signal to the external device includes not sending an ACK signal being a positive response signal.

12. The method of claim 10, wherein
the specific condition includes a case where the received data packet is invalid and there are no data to be transmitted to the external device,
based on the specific condition being satisfied, the keeping silent without sending the response signal to the external device includes not sending a NACK signal being a negative response signal.

13. The method of claim 10, wherein the determining whether the specific condition is satisfied in which the response signal is not transmitted includes:
determining whether the data packet is valid;
based on the data packet being invalid, determining whether there are data to be transmitted to the external device;
based on the data packet being valid, determining whether there are the data to be transmitted to the external device; and
based on the data packet being valid and the data to be transmitted to the external device not existing, determining whether a current sub-event is a last sub-event just before a flush point corresponding to the received data packet.

14. The method of claim 13, further comprising:
based on the data packet being invalid and the data to be transmitted to the external device existing, sending a NACK signal being a negative response signal together with the data to the external device; and
based on the data packet being invalid and the data to be transmitted to the external device not existing, not sending the NACK signal to the external device.

15. The method of claim 13, further comprising:
based on the data packet being valid and the data to be transmitted to the external device existing, sending an ACK signal being a positive response signal to the external device together with the data.

16. The method of claim 13, further comprising:
based on the data packet being valid, the data to be transmitted to the external device not existing, and the current sub-event not being the last sub-event just before the flush point corresponding to the received data packet, sending an ACK signal being a positive response signal to the external device; and
based on the received data packet being valid, the data to be transmitted to the external device not existing, and the current sub-event being the last sub-event just before the flush point corresponding to the received data packet, not sending the ACK signal to the external device.

17. An electronic device comprising:
a host; and
a controller configured to:
determine whether to send a response signal, based on valid information indicating validation of a data packet received from an outside, data check information indicating whether there are data to be transmitted to the outside, and flush information indicating whether a current sub-event is a last sub-event just before a flush point for the received data packet, in response to the received data packet; and
send no response signal to the outside based on a specific condition being satisfied in which the response signal is not transmitted.

18. The electronic device of claim 17, wherein the controller is further configured to
determine whether the received data packet is valid and generate the valid information; determine whether there are the data to be transmitted to the outside and generate the data check information;
determine whether the current sub-event is the last sub-event just before the flush point for the received data packet and generate the flush information; and
determine whether to send the response signal, based on the valid information, the data check information, and the flush information.

19. The electronic device of claim 17, wherein the specific condition in which the response signal is not transmitted includes:
a first case including the received data packet being invalid and the data to be transmitted to the outside not existing; and
a second case including the received data packet being valid, the data to be transmitted to the outside not existing, and the current sub-event being the last sub-event just before the flush point for the received data packet.

20. The electronic device of claim 17, wherein an LE Audio protocol being a Bluetooth Low Energy (LE) based audio streaming technology is configured to perform communication with the outside.
